(19) United States
(12) Patent Application Publication
(10) Pub. No.: US 2006/0010620 A1
(43) Pub. Date: Jan. 19, 2006

(54) Textile spun-dyed fiber material and use thereof for producing camouflage articles

(75) Inventors: Guido Krabbe, Eppstein-Ehlhalten (DE); Horst-Roland Mach, Glashutten (DE)

Correspondence Address: CONNOLLY BOVE LODGE & HUTZ, LLP, P O BOX 2207, WILMINGTON, DE, 19899, US

(73) Assignee: DyStar Textilfarben GmbH & Co. Deutschland KG, Frankfurt am Main (DE)

(21) Appl. No.: 10/524,490

(22) PCT Filed: Aug. 16, 2003
(86) PCT No.: PCT/EP03/09097

§ 371 Date: Feb. 14, 2005

(30) Foreign Application Priority Data
Aug. 24, 2002 (DE) 102 38 890.3

(51) Int. Cl. C09B 67/00

(52) U.S. Cl. 8/638

(57) ABSTRACT

The present invention relates to textile fiber material comprising spun-dyed aramid fibers or mixtures of spun-dyed aramid fibers and undyed cellulosic fibers for producing military camouflage articles, wherein the aramid fiber fraction is spun-dyed with a colorant having a chlorophyll-like reflectance in the IR region, and to its use for producing military camouflage print articles.

The present invention relates to textile fiber material comprising spun-dyed aromatic polyamide fibers (aramid fibers) or mixtures of spun-dyed aramid fibers with undyed cellulosic fibers and to its use for producing camouflage articles.

Textiles for military applications, especially uniforms and combat suits, are required by various military authorities to be low flammable or flame retardant. At the same time, properties such as colorfastnesses, IR reflectance characteristics, camouflaging effect due to patterning/coloration and wear properties shall not be inferior to what is achievable with hitherto customary textile materials.

For low-flammable textiles the obvious choice is aramid fibers. However, conventional printing and dyeing processes do not provide products having adequate colorfastnesses. Similarly, the stipulated infrared reflectance performance (chlorophyll-like reflectance curve) cannot be achieved.

It is an object of the present invention to provide a process for producing camouflage articles based on aramid fibers or based on mixtures of aramid fibers and cellulosic fibers which provides the abovementioned performance profile stipulated by military authorities.

EP 1 111 124 A1 discloses a process for producing textile camouflage articles which comprises a spun-dyed fiber material composed of synthetic fibers or of a mixture of synthetic fiber and cellulosic fiber being printed with camouflage patterns. In the spun-dyed textile material, even in the case where it is a fiber blend, only the synthetic fiber fraction is spun-dyed with a dye having a chlorophyll-like reflectance in the IR region. Only the cellulosic fiber portion is then dyed in the second step. The synthetic fibers specified in this cited document are in particular polyester fibers and (aliphatic) polyamide fibers.

It has now been found that, surprisingly, textiles based on aramid fibers or based on mixtures of aramid fibers and cellulosic fibers can be respectively dyed and printed in similar manner to that indicated in EP 1 111 124 A1. This was unforeseeable because the colorants used for prior art spin dyeing do not withstand the requirements needed for spinning aramid, such as thermal requirements or solvent resistance.

Accordingly, military requirements can be met by having a fiber material in which the fraction of aramid fibers has been spun dyed with a certain colorant which has the required IR reflectance characteristics subsequently cross-printed or -dyed, although in the case of cellulosic blend substrates it is only the cellulose fraction which is printed or dyed in this second step.

This process has the additional advantage that it is no longer necessary to use two dye classes and distinct fixing operations when printing or dyeing blend fabrics, since the aramid fiber fraction has already been covered by the spin dyeing, which also already comprises the desired chlorophyll-like IR reflectance.

The present invention thus provides a textile fiber material comprising spun-dyed aramid fibers or mixtures of spun-dyed aramid fibers and undyed cellulosic fibers for producing military camouflage articles, wherein the aramid fiber fraction is spun-dyed with a colorant having a chlorophyll-like reflectance in the IR region.

The present invention also provides for the use of textile fiber material comprising spun-dyed aramid fibers for producing military camouflage print articles, which comprises camouflage patterns being printed on in a conventional manner.

The present invention further provides for the use of textile fiber material comprising mixtures of spun-dyed aramid fibers and undyed cellulosic fibers for producing military camouflage articles, which comprises the cellulose fraction being dyed or camouflage printed.

The textile fiber materials of the present invention are in particular wovens or formed-loop knits and can consist of aramid fibers only. But preferably they consist of mixtures of aramid fibers with cellulose. Particular preference is given to mixtures of aramid fibers and low-flammability regenerated cellulose fibers, such as for example Lenzing AG's commercial product Lenzing FR.

With regard to the end use, the aramid fiber fraction of the textile fiber materials according to the present invention is generally spun dyed in a medium gray, green, brown or olive shade. Useful colorants, i.e. dyes and pigment preparations, include all colorants which are suitable for spin dyeing, which meet the requirements for the spin dyeing of aramid fibers and which have the necessary chlorophyll-like reflectance in the IR region.

These colorants can be used alone or mixed with each other. To obtain the desired basic hues, they can further be combined with further colorants useful in spin dyeing. However, care must always be taken to ensure that the IR reflectance characteristics of the end product do not have a disruptive or adverse effect on the chlorophyll-typical curve. Provided this prerequisite is met, the mixing ratios of the individual colorants used are not critical and are only determined by the desired basic hue.

Preferred colorants useful for spin dyeing the aramid fiber fraction include for example C.I. Vat Blue 05, C.I. Vat Blue 64, C.I. Vat Blue 66, C.I. Pigment Blue 15, C.I. Pigment Blue 15.1, C.I. Pigment Blue 15.3, C.I. Pigment Blue 28, C.I. Pigment Green 7, C.I. Pigment Green 17, C.I. Pigment Green 36, C.I. Pigment Green 50, C.I. Pigment Black 7, C.I. Pigment Black 11, C.I. Pigment Black 32, C.I. Pigment Yellow 42, C.I. Pigment Yellow 53, C.I. Pigment Yellow 83, C.I. Pigment Yellow 110, C.I. Pigment Yellow 138, C.I. Pigment Yellow 139, C.I. Pigment Yellow 164, C.I. Pigment Yellow 183, C.I. Pigment Yellow 184, C.I. Pigment Brown 24, C.I. Pigment Brown 29, C.I. Pigment Brown 31, C.I. Pigment White 6, C.I. Pigment Red 101, C.I. Pigment Red 144, C.I. Pigment Red 149, C.I. Pigment Red 178 and C.I. Pigment Red 179, which are all known and commercially available or preparable by methods known to one skilled in the art. Preference is also given to the commercial products Sicomix® IR-Schwarz 00-6760 and Sicomix® Schwarz 00-8530 from BASF AG, and also Bayferrox Rot 600, Bayferrox Rot 655 and Bayferrox 960 from Bayer AG.

The spin dyeing process is known per se. In spin dyeing, the spinning solution or melt is admixed with pigment dyes or soluble dyes which remain in the fiber at the coagulation stage and thus color the fiber. The colorants are preferably added in the form of masterbatches which may already contain any assistants required. Details concerning spin dyeing may be found in Römpp Chemielexikon, 9th edition, 1992, Volume 5, page 4247 and especially the references cited therein. Aramids suitable for producing aramid fibers are known and can be commercially acquired.

Textile fiber material according to the present invention that consists exclusively of spun-dyed aramid fibers is also useful as such for camouflage articles when a solid color is acceptable. In this case, the desired hue is obtained exclusively by spin dyeing using appropriate amounts of colorant.

Generally, however, it is used for producing military camouflage print articles. To this end, the desired camouflage patterns are printed on in the corresponding camouflage hues in a second step. This step may employ the same colorants as already used in spin dyeing, but advantageously customary textile print pigment preparations are used for this purpose. It is advantageous in this case to produce the spin dyeing in that shade which corresponds to the lightest hue of the camouflage print pattern and to print on the darker patterns. The lightest hue is generally light green, khaki or light olive.

When the textile fiber material of the present invention comprises a mixture of spun-dyed aramid fibers and undyed cellulosic fibers, it can be used for producing military camouflage articles by exclusively dyeing or printing the cellulose fraction in a second operation. If a single-colored end product is to be obtained, the spun-dyed product is cross-dyed with a dye suitable for cellulosic fibers. It is advantageous here for the hue produced by the spin dyeing to be very close to the final hue.

Generally, however, the textile fiber materials of the present invention that comprise a mixture of spun-dyed aramid fibers and undyed cellulosic fibers are printed with camouflage patterns in a second operation, again using dyes suitable for cellulose. It is preferable in this case for the spin dyeing to be executed in a medium gray, green, brown or olive hue and for the subsequent printing to be executed with typical camouflage print hues (according to the requirements of the respective army) such as black, brown and various olive or green shades. The medium shades of the spin-dyeing are blotted out by the deeper overprinted shades and do not adversely disrupt the overall appearance of the finished product.

Useful colorants for dyeing or printing the cellulose fraction include all colorants suitable for cellulose, although care must be taken to ensure that their IR reflectance curve is similar to that of chlorophyll or at least does not adversely affect the reflectance curve of the dye used in spin dyeing. Moreover, the colorants used have to meet the particular colorfastness requirements.

In one version of the present invention, however, it is also possible to print with an extremely low reflectance black dye which completely eliminates the chlorophyll-like reflectance curve. In this case, the IR reflectance values correspond for example to those of natural soil, so that their use for camouflaging purposes is advantageous here too. It is especially the combination of chlorophyll-like reflectance and low reflectance which was responsible for the camouflage effect.

The colorants useful for dyeing and printing the cellulose fraction can likewise be used alone or mixed with each other in wide mixing ratios.

Preferred dyes for cellulose are in particular vat dyes and sulfur dyes.

Particularly useful dyes are C.I. Vat Yellow 4, C.I. Vat Yellow 33, C.I. Vat Yellow 46, C.I. Vat Orange 1, C.I. Vat Orange 7, C.I. Vat Orange 11, C.I. Vat Orange 15, C.I. Vat Blue 5, C.I. Vat Blue 19, C.I. Vat Blue 66, C.I. Vat Green 1, C.I. Vat Green 3, C.I. Vat Green 9, C.I. Vat Green 13, C.I. Vat Brown 1, C.I. Vat Brown 3, C.I. Vat Brown 57, C.I. Vat Black 7, C.I. Vat Black 8, C.I. Vat Black 9, C.I. Vat Black 19, C.I. Vat Black 25, C.I. Vat Black 27, C.I. Vat Olive 27, C.I. Sulfur Black 1, C.I. Sulfur Black 6 and C.I. Sulfur Black 7.

The cellulose fraction of the textile spun-dyed fiber material of the present invention can be dyed and printed according to conventional methods for applying the various classes of dye, for example as described in H. Rath, Lehrbuch der Textilchemie, Springer Verlag, Berlin, Heidelberg, N.Y., 3rd edition 1972, especially pages 557-568, 571-575, 678-683 and 703-704 or in M. Peter and H. K. Rouette, Grundlagen der Textilveredlung, Deutscher Fachverlag, 13th revised edition, 1989, especially pages 500-509 and 624-625.

### EXAMPLE 1

An aramid fiber spin dyeing masterbatch consisting of 5% of Vat Blue 66, 5% of dope (20% of dry polymer, 80% of solvent) and 90% of solvent is mixed with the actual dope in a ratio of masterbatch:dope=1:16 upstream of the spinneret die and then conjointly extruded and precipitated in a coagulation bath consisting of water and solvent. The solvent used is a customary polar aprotic spin dyeing solvent. The fiber thus obtained is spun in a 50:50 blend with regenerated cellulose into a yarn and subsequently processed into a woven or loop-formingly knitted fabric. The result is a textile product having an olive green hue.

### EXAMPLE 2

An aramid fiber spin dyeing masterbatch consisting of 0.8% of Pigment Blue 15.1, 3.2% of Pigment Red 144, 6% of dope (25% of dry polymer, 75% of solvent) and 90% of solvent is mixed with the actual dope in a ratio of masterbatch:dope=1:115 upstream of the spinneret die and then conjointly extruded and precipitated in a coagulation bath consisting of water and solvent. The solvent used is a customary polar aprotic spin dyeing solvent.

The fiber thus obtained is spun in a 50:50 blend with regenerated cellulose into a yarn and subsequently processed into a woven or loop-formingly knitted fabric. The result is a textile product having a beige hue.

### EXAMPLE 3

An aramid fiber spin dyeing masterbatch consisting of 1.4% of Pigment Blue 15.1, 1.4% of Pigment Red 144 and 2.4% of Pigment Yellow 110, 4.8% of dope (20% of dry polymer, 80% of solvent) and 90% of solvent is mixed with the actual dope in a ratio of masterbatch:dope=1:20 upstream of the spinneret die and then conjointly extruded and precipitated in a coagulation bath consisting of water and solvent. The solvent used is a customary polar aprotic spin dyeing solvent.

The fiber thus obtained is spun in a 50:50 blend with regenerated cellulose into a yarn and subsequently processed into a woven or loop-formingly knitted fabric. The result is a textile product having a brown hue.

### EXAMPLES 4 TO 8

The textile materials obtained as per Examples 1 to 3 are printed with a camouflage shade in a subsequent step by using print pastes of the following composition:

### EXAMPLE 4

6.5 g/kg of C.I. Vat Yellow 46
15 g/kg of C.I. Vat Yellow 4
24 g/kg of C.I. Vat Blue 66
700 g/kg of thickening for 2-step fixation
254.5 g/kg balance (water or thickening)

1,000.00 g

A customary 2-step fixation for vat dyes provides a dark green hue having a reflectance profile which is similar to that of chlorophyll.

### EXAMPLE 5

6.0 g/kg of C.I. Vat Yellow 46
2.5 g/kg of C.I. Vat Yellow 4
1.8 g/kg of C.I. Vat Blue 66
700 g/kg of thickening for 2-step fixation
289.7 g/kg balance (water or thickening)
1,000.00 g

A customary 2-step fixation for vat dyes provides a light green hue having a reflectance profile which is similar to that of chlorophyll.

### EXAMPLE 6

40.0 g/kg of C.I. Vat Brown 57
700 g/kg of thickening for 2-step fixation
260.0 g/kg balance (water or thickening)
1,000.00 g

A customary 2-step fixation for vat dyes provides a brown hue having a reflectance profile which is similar to that of chlorophyll.

### EXAMPLE 7

120.0 g/kg of C.I. Sulphur Black 6
700 g/kg of thickening for 2-step fixation
180.0 g/kg balance (water or thickening)
1,000.00 g

A customary 2-step fixation for vat dyes provides a black hue having a reflectance profile which is similar to that of chlorophyll.

### EXAMPLE 8

20.0 g/kg of C.I. Vat Yellow 04
1.9 g/kg of C.I. Vat Orange 07
6.1 g/kg of C.I. Vat Blue 66
700.0 g/kg of thickening for 2-step fixation
272.0 g/kg balance (water or thickening)
1,000.00 g

A customary 2-step fixation for vat dyes provides a light green hue having IR reflectance values which are very close to those of natural chlorophyll.

### EXAMPLE 9

The textile materials obtained as per Examples 1 to 3 are cross-dyed in a subsequent step with a mixture of the following vat dyes in a continuous dyeing operation:
5.9 g/l of C.I. Vat Orange 01
7.9 g/l of C.I. Vat Blue 66
3.8 g/l of C.I. Vat Olive 27

1. Textile fiber material comprising spun-dyed aramid fibers or mixtures of spun-dyed aramid fibers and undyed cellulosic fibers for producing military camouflage articles, wherein the aramid fiber fraction is spun-dyed with a colorant having a chlorophyll-like reflectance in the IR region.

2. The textile fiber material of claim 1, wherein the aramid fiber fraction is spun-dyed with C.I. Vat Blue 05, C.I. Vat Blue 64, C.I. Vat Blue 66, C.I. Pigment Blue 15, C.I. Pigment Blue 15.1, C.I. Pigment Blue 15.3, C.I. Pigment Blue 28, C.I. Pigment Green 7, C.I. Pigment Green 17, C.I. Pigment Green 36, C.I. Pigment Green 50, C.I. Pigment Black 7, C.I. Pigment Black 11, C.I. Pigment Black 32, C.I. Pigment Yellow 42, C.I. Pigment Yellow 53, C.I. Pigment Yellow 83, C.I. Pigment Yellow 110, C.I. Pigment Yellow 138, C.I. Pigment Yellow 139, C.I. Pigment Yellow 164, C.I. Pigment Yellow 183, C.I. Pigment Yellow 184, C.I. Pigment Brown 24, C.I. Pigment Brown 29, C.I. Pigment Brown 31, C.I. Pigment White 6, C.I. Pigment Red 101, C.I. Pigment Red 144, C.I. Pigment Red 149, C.I. Pigment Red 178, C.I. Pigment Red 179 or the commercial products Sicomix® IR-Schwarz 00-6760, Sicomix® Schwarz 00-8530, Bayferrox Rot 600, Bayferrox Rot 655 or Bayferrox 960.

3. The textile fiber material of claim 1, comprising a mixture of aramid fibers and low-flammable regenerated cellulose fibers.

4-9. (canceled)

10. A process to produce a military camouflage article which comprises printing the camouflage pattern on the textile fiber material as claimed in claim 1.

11. A process to produce a military camouflage article which comprises dying the undyed cellulose fiber fraction of the textile fiber material as claimed in claim 1 or printing a camouflage pattern on the textile fiber material as claimed in claim 1.

12. The process as claimed in claim 11, wherein an aramid fiber material spun-dyed in medium gray, green, brown or olive shades is cross-printed with camouflage patterns in black, brown, olive or green shades.

13. The process as claimed in claim 11, wherein the cellulose fraction is dyed or printed with vat or sulfur dyes.

14. The process as claimed in claim 13, wherein the vat dyes used are C.I. Vat Yellow 4, C.I. Vat Yellow 33, C.I. Vat Yellow 46, C.I. Vat Orange 1, C.I. Vat Orange 7, C.I. Vat Orange 11, C.I. Vat Orange 15, C.I. Vat Blue 5, C.I. Vat Blue 19, C.I. Vat Blue 66, C.I. Vat Green 1, C.I. Vat Green 3, C.I. Vat Green 9, C.I. Vat Green 13, C.I. Vat Brown 1, C.I. Vat Brown 3, C.I. Vat Brown 57, C.I. Vat Black 7, C.I. Vat Black 8, C.I. Vat Black 9, C.I. Vat Black 19, C.I. Vat Black 25, C.I. Vat Black 27 or C.I. Vat Olive 27.

15. The process as claimed in claim 13, wherein the sulfur dyes used are C.I. Sulfur Black 1, C.I. Sulfur Black 6 or C.I. Sulfur Black 7.
